(19) United States
(12) Patent Application Publication
(10) Pub. No.: US 2013/0002727 A1
(43) Pub. Date: Jan. 3, 2013

(54) INPUT DEVICE WITH MULTIPLE LAYERS OF LUMINOUS PATTERNS

(75) Inventor: Chung-Yuan Chen, Taipei (TW)

(73) Assignee: PRIMAX ELECTRONICS LTD., Taipei (TW)

(21) Appl. No.: 13/222,541

(22) Filed: Aug. 31, 2011

(30) Foreign Application Priority Data
Jul. 1, 2011 (TW) 100123290

(51) Int. Cl. G09G 5/10

(52) U.S. Cl. 345/690

(57) ABSTRACT

An input device with multiple layers of luminous patterns is provided. The input device includes an input interface, a first illumination module, a second illumination module and a circuit board. The circuit board is parallel with the first illumination module and the second illumination module. A first edge of the circuit board is inserted into a gap between the first illumination module and the second illumination module. Consequently, the first light beams from the first illumination module and the second light beams from the second illumination module are blocked by the first edge of the circuit board.

### FIELD OF THE INVENTION

The present invention relates to an input device, and more particularly to an input device with multiple layers of luminous patterns.

### BACKGROUND OF THE INVENTION

With increasing development of science and technology, various touch-sensitive input devices are introduced into the market. The touch-sensitive input device may be operated in two different input modes. In addition, the touch-sensitive input device has an illumination module. In a case that the illumination module is enabled, a preset pattern of the touch-sensitive input device is visible, and thus the touch-sensitive input device is operated in a first input mode. Whereas, in a case that the illumination module is disabled, the preset pattern is invisible, and thus the touch-sensitive input device is operated in a second input mode. That is, the user may realize the current input mode of the touch-sensitive input device by judging whether the preset pattern is visible or not. For example, if the illumination module is disabled, the overall outward appearance of the touch-sensitive input device looks black, and the input mode is a preset mouse cursor control mode. Under this circumstance, the user may perform a mouse-moving action or a clicking action by operating the overall black touch-sensitive input device. Whereas, if the illumination module is enabled, the touch-sensitive input device is shown as a luminous keyboard, and the input mode is a preset keyboard control mode. Under this circumstance, the user may input characters and symbols via the touch-sensitive input device according to the visible luminous pattern. For avoiding the user's confusion, the luminous touch-sensitive input device should be specially designed to make the preset pattern invisible when the illumination module is disabled and make the preset pattern visible when illumination module is enabled.

FIG. 1 is a schematic side view illustrating a conventional luminous input device. The conventional luminous input device 1 comprises an input interface 11, an illumination module 12 and a Mylar plate 13. From bottom to top, the input interface 11, the illumination module 12 and the Mylar plate 13 are sequentially shown. In a case that the input interface 11 is triggered by a user's finger or a pen, a corresponding touching signal is generated. The illumination module 12 comprises a light-emitting element 121 and a light-guiding plate 122. The light-emitting element 121 is used for emitting first light beams (not shown). The light-guiding plate 122 is located beside the light-emitting element 121 for guiding the first light beams to the input interface 11. For example, the light-emitting element 121 is a light emitting diode (LED). The Mylar plate 13 has a plurality of luminous patterns 131. These luminous patterns 131 are disposed on a bottom surface 133 of the Mylar plate 13. In addition, the luminous patterns 131 are formed by printing a black light-shading ink having a light-shading percentage of about 98%. The regions of the bottom surface 133 of the Mylar plate 13 excluding the luminous patterns 131 are light-shading layers 132. These light-shading layers 132 are formed by printing a black opaque ink. Consequently, the light beams are only permitted to be transmitted through the regions of the bottom surface 133 of the Mylar plate 13 that are printed with the luminous patterns 131; and the light beams fail to be transmitted through the light-shading layers 132.

In a case that the illumination module 12 of the luminous input device 1 is disabled, the weak ambient light beams from the surroundings may be directed into the luminous input device 1. Since the luminous patterns 131 have the light-shading percentage of about 98%, only 2% of the ambient light beams can be transmitted through the luminous patterns 131. Since the ambient light beams are too weak, the luminous patterns 131 of the Mylar plate 13 fail to be recognized by naked eyes. In other words, the luminous patterns 131 are invisible. Whereas, when the illumination module 12 of the luminous input device 1 is enabled, a great number of first light beams are directed into the luminous input device 1. Although only 2% of the light beams from the illumination module 12 can be transmitted through the Mylar plate 13, the light intensity is sufficient to be recognized by the human's eyes. Under this circumstance, the luminous patterns 131 are visible, and thus the user can recognize the touched position corresponding to the luminous patterns 131 of the luminous input device 1. The configurations and functions of the conventional touch-sensitive input device have been illustrated as above.

With increasing development of science and technology, the functions of the touch-sensitive input device become more diverse. Nowadays, an input device with multiple layers of luminous patterns is introduced into the market. FIG. 2 is a schematic side view illustrating an input device with multiple layers of luminous patterns according to the prior art. As shown in FIG. 2, the input device 2 comprises an input interface 21, a first illumination module 22, a second illumination module 23, a circuit board 24, a light-shading plate 25 and a protective layer 26. From bottom to top, the input interface 21, the second illumination module 23, the light-shading plate 25, the first illumination module 22 and the protective layer 26 are sequentially shown.

The first illumination module 22 comprises a first light-emitting element 221 and a first light-guiding plate 222. The first light-emitting element 221 is used for emitting first light beams (not shown). The first light-guiding plate 222 is located beside the first light-emitting element 221 for guiding the first light beams to the input interface 21. In addition, the first light-guiding plate 222 has a plurality of first luminous patterns 2221. The first luminous patterns 2221 are disposed on a bottom surface 2222 of the first light-guiding plate 222. That is, when the first light beams are emitted by the first light-emitting element 221, the first luminous patterns 2221 of the first light-guiding plate 222 are illuminated to be visible. Moreover, the first luminous patterns 2221 are collectively defined as an alphanumeric keyboard interface for inputting letters and numbers.

The second illumination module 23 comprises a second light-emitting element 231 and a second light-guiding plate 232. The second light-emitting element 231 is used for emitting second light beams (not shown). The second light-guiding plate 232 is located beside the second light-emitting element 231 for guiding the second light beams to the input interface 21. In addition, the second light-guiding plate 232 has a plurality of second luminous patterns 2321. The second luminous patterns 2321 are disposed on a bottom surface 2322 of the second light-guiding plate 232. That is, when the second light beams are emitted by the second light-emitting element 231, the second luminous patterns 2321 of the second light-guiding plate 232 are illuminated to be visible. Moreover, the second luminous patterns 2321 are collectively defined as a Chinese keyboard interface for inputting Chinese characters. In addition, the light-emitting element 221 and the light-emitting element 231 are light emitting diodes.

Please refer to FIG. 2 again. The protective layer 26 is disposed over the first illumination module 22. The protective layer 26 is used for protecting the first illumination module 22 from being collided or rubbed by the external force. The protective layer 26 has a light-shading layer 261. The light-shading layer 261 is disposed over a top surface 262 of the protective layer 26 for shading most of the first light beams, most of the second light beams or most of the external light beams. The light-shading layer 261 is formed by printing a light-shading ink on the top surface 262 of the protective layer 26. In addition, the light-shading layer 261 has a preset light-shading percentage of about 98%. The circuit board 24 is located beside the first illumination module 22 and the second illumination module 23. In addition, the circuit board 24 is perpendicular to the light-shading plate 25. The first light-emitting element 221 and the second light-emitting element 231 are disposed on the circuit board 24. As shown in FIG. 2, the first light-emitting element 221 and the second light-emitting element 231 are front-view light emitting diodes.

The light-shading plate 25 is arranged between the first light-guiding plate 222 and the second light-guiding plate 232 for shading the first light beams that are emitted by the first light-emitting element 221. Since the first light beams are not directed to the second light-guiding plate 232, the second luminous patterns 2321 of the second illumination module 23 on the second light-guiding plate 232 are not influenced by the first light beams. Similarly, the second light beams from the second light-emitting element 231 are also shaded by the light-shading plate 25. Since the first light beams are not directed to the first light-guiding plate 222, the first luminous patterns 2221 of the first illumination module 22 on the first light-guiding plate 222 are not influenced by the second light beams.

In a case that the first illumination module 22 and the second illumination module 23 of the input device 2 are disabled, the weak ambient light beams from the surroundings may be directed into the luminous input device 2. Since the light-shading layer 261 has the preset light-shading percentage of about 98%, only 2% of the ambient light beams can be transmitted through the light-shading layer 261. Since the ambient light beams are too weak, the ambient light beams fail to be recognized by naked eyes. Consequently, the first luminous patterns 2221 and the second luminous patterns 2321 on the first light-guiding plate 222 and the second light-guiding plate 232 are invisible. That is, these luminous patterns are not viewed by the user. Whereas, when the first illumination module 22 of the input device 2 is enabled, a great number of first light beams are directed into the input device 2. Although only 2% of the light beams from the first illumination module 22 can be transmitted through the light-shading layer 261, the light intensity is sufficient to be recognized by the human's eyes. Under this circumstance, the first luminous patterns 2221 are visible, and thus the user can recognize the touched position corresponding to the first luminous patterns 2221 of the input device 2. The operations of enabling the second illumination module 23 of the input device 2 of this embodiment are similar to those of the first illumination module 22, and are not redundantly described herein.

From the above discussions, the input device 2 can provide two types of luminous patterns. By judging whether the first luminous patterns 2221 or the second luminous patterns 2321 are visible, the user may realize the current keyboard mode of the input device 2. However, the conventional input device 2 still has some drawbacks. For example, since the circuit board 24 is perpendicular to the first light-guiding plate 222, the overall thickness of the input device 2 is too large.

### SUMMARY OF THE INVENTION

The present invention relates to a slim input device with multiple layers of luminous patterns.

In accordance with an aspect of the present invention, there is provided an input device with multiple layers of luminous patterns. The input device includes an input interface, a circuit board, a first illumination module and a first illumination module. When the input interface is triggered, a touching signal is generated. The circuit board is disposed under the input interface. The first illumination module is disposed on a first surface of the circuit board for emitting first light beams. The first illumination module has a first luminous pattern. When the first light beams are transmitted through the input interface, the first luminous pattern is visible through the input interface. The second illumination module is disposed on a second surface of the circuit board for emitting second light beams. The second illumination module has a second luminous pattern. When the second light beams are transmitted through the input interface, the second luminous pattern is visible through the input interface. In addition, a first edge of the circuit board is inserted into a gap between the first illumination module and the second illumination module for blocking the first light beams or the second light beams.

In an embodiment, the input device further includes a protective layer, which is disposed over the input interface for protecting the input interface. The protective layer includes a light-transmissible zone and a light-shading zone. The light-shading zone is located around the light-transmissible zone for shading the first light beams or the second light beams. In response to the first light beams or the second light beams, the first luminous pattern or the second luminous pattern are visible through the light-transmissible zone. Moreover, the light-transmissible zone has a preset light-shading percentage. If the first illumination module or the second illumination module is disabled and the first light beams or the second light beams are not generated, the first luminous pattern of the first illumination module or the second illumination module of the second luminous pattern is invisible according to the preset light-shading percentage.

In an embodiment, if the first light beams or the second light beams are not generated, an external light beam from surroundings of the input device is blocked by the light-shading zone having the preset light-shading percentage, so that the first luminous pattern or the second luminous pattern is invisible. Preferably, the preset light-shading percentage is in a range between 75% and 80%.

In an embodiment, the first illumination module includes a first light-emitting element and a first light-guiding plate. The first light-emitting element is disposed on the first surface of the circuit board for emitting the first light beams. The first light-guiding plate is stacked on the first surface of the circuit board and located at a first side of the first light-emitting element for guiding the first light beams to the input interface. The second illumination module includes a second light-emitting element and a second light-guiding plate. The second light-emitting element is disposed on the second surface of the circuit board for emitting the second light beams. The second light-guiding plate is stacked on the second surface of the circuit board and located at a first side of the second light-emitting element for guiding the second light beams to the input interface.

In an embodiment, the first light-emitting element and the second light-emitting element are both side-view light emitting diodes. Moreover, the circuit board is parallel with the first light-guiding plate and the second light-guiding plate.

In an embodiment, the first luminous pattern is disposed on a top surface or a bottom surface of the first light-guiding plate. The second luminous pattern is disposed on a top surface or a bottom surface of the second light-guiding plate. Moreover, each of the first luminous pattern and the second luminous pattern includes a plurality of closely packed light-guiding microstructures.

In an embodiment, a white glare solder-resistant ink layer is further formed on the circuit board for reflecting the first light beams or the second light beams. The white glare solder-resistant ink layer is printed on the first surface and the second surface of the circuit board.

In accordance with another aspect of the present invention, there is provided an input device with multiple layers of luminous patterns. The input device includes an input interface, a circuit board, a first illumination module, a first illumination module and a light-shading structure. When the input interface is triggered, a touching signal is generated. The circuit board is disposed under the input interface. The first illumination module is disposed on a first surface of the circuit board for emitting first light beams. The first illumination module has a first luminous pattern. When the first light beams are transmitted through the input interface, the first luminous pattern is visible through the input interface. The second illumination module is disposed on a second surface of the circuit board for emitting second light beams. The second illumination module has a second luminous pattern. When the second light beams are transmitted through the input interface, the second luminous pattern is visible through the input interface. The light-shading structure is located at a first side of the circuit board and arranged between the first illumination module and the second illumination module for blocking the first light beams or the second light beams.

In an embodiment, the input device further includes a protective layer, which is disposed over the input interface for protecting the input interface. The protective layer includes a light-transmissible zone and a light-shading zone. The light-shading zone is located around the light-transmissible zone for shading the first light beams or the second light beams. In response to the first light beams or the second light beams, the first luminous pattern or the second luminous pattern are visible through the light-transmissible zone. Moreover, the light-transmissible zone has a preset light-shading percentage. If the first illumination module or the second illumination module is disabled and the first light beams or the second light beams are not generated, the first luminous pattern of the first illumination module or the second illumination module of the second luminous pattern is invisible according to the preset light-shading percentage.

In an embodiment, if the first light beams or the second light beams are not generated, an external light beam from surroundings of the input device is blocked by the light-shading zone having the preset light-shading percentage, so that the first luminous pattern or the second luminous pattern is invisible. Preferably, the preset light-shading percentage is in a range between 75% and 80%.

In an embodiment, the first illumination module includes a first light-emitting element and a first light-guiding plate. The first light-emitting element is disposed on the first surface of the circuit board for emitting the first light beams. The first light-guiding plate is stacked on the first surface of the circuit board and located at a first side of the first light-emitting element for guiding the first light beams to the input interface. The second illumination module includes a second light-emitting element and a second light-guiding plate. The second light-emitting element is disposed on the second surface of the circuit board for emitting the second light beams. The second light-guiding plate is stacked on the second surface of the circuit board and located at a first side of the second light-emitting element for guiding the second light beams to the input interface.

In an embodiment, the first light-emitting element and the second light-emitting element are both side-view light emitting diodes. Moreover, the circuit board is parallel with the first light-guiding plate and the second light-guiding plate.

In an embodiment, the first luminous pattern is disposed on a top surface or a bottom surface of the first light-guiding plate. The second luminous pattern is disposed on a top surface or a bottom surface of the second light-guiding plate. Moreover, each of the first luminous pattern and the second luminous pattern includes a plurality of closely packed light-guiding microstructures.

In an embodiment, the light-shading structure is disposed on a bottom surface of the first light-guiding plate or a top surface of the second light-guiding plate. Moreover, the light-shading structure is formed by painting, spraying, printing or bonding a light-shading material on the bottom surface of the first light-guiding plate or the top surface of the second light-guiding plate.

In an embodiment, the light-shading structure is a plastic sheet, a sponge structure or a light-shading plate. The light-guiding structure is disposed within a gap between the first light-guiding plate and the second light-guiding plate and located at a first side of the circuit board.

In an embodiment, a white glare solder-resistant ink layer is further formed on the circuit board for reflecting the first light beams or the second light beams, wherein the white glare solder-resistant ink layer is printed on the first surface and the second surface of the circuit board.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a conventional luminous input device;

FIG. 2 is a schematic side view illustrating an input device with multiple layers of luminous patterns according to the prior art;

FIG. 3 is a schematic side view illustrating an input device with multiple layers of luminous patterns according to a first embodiment of the present invention;

FIG. 4 schematically illustrates the first light-emitting element and the second light-emitting element mounted on the circuit board of the input device with multiple layers of luminous patterns according to the first embodiment of the present invention and taken along another viewpoint;

FIG. 5 is a schematic top view illustrating the input device with multiple layers of luminous patterns according to the first embodiment of the present invention, in which the first light-emitting element of the first illumination module is turned on;

FIG. 6 is a schematic top view illustrating the input device with multiple layers of luminous patterns according to the first embodiment of the present invention, in which the second light-emitting element of the second illumination module is turned on;

FIG. 7 is a schematic side view illustrating an input device with multiple layers of luminous patterns according to a second embodiment of the present invention; and

FIG. 8 is a schematic side view illustrating an input device with multiple layers of luminous patterns according to a third embodiment of the present invention.

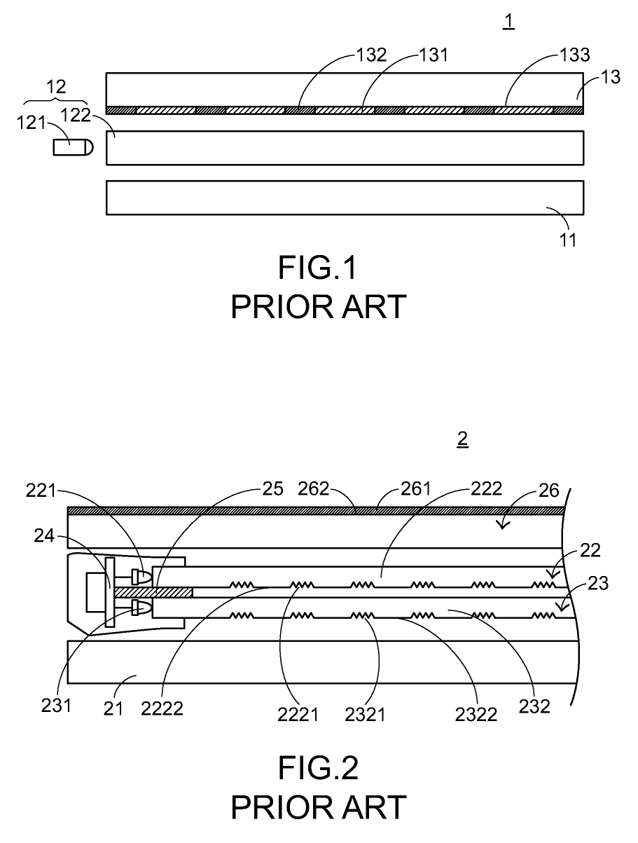

### DETAILED DESCRIPTION OF THE PREFERRED EMBODIMENT

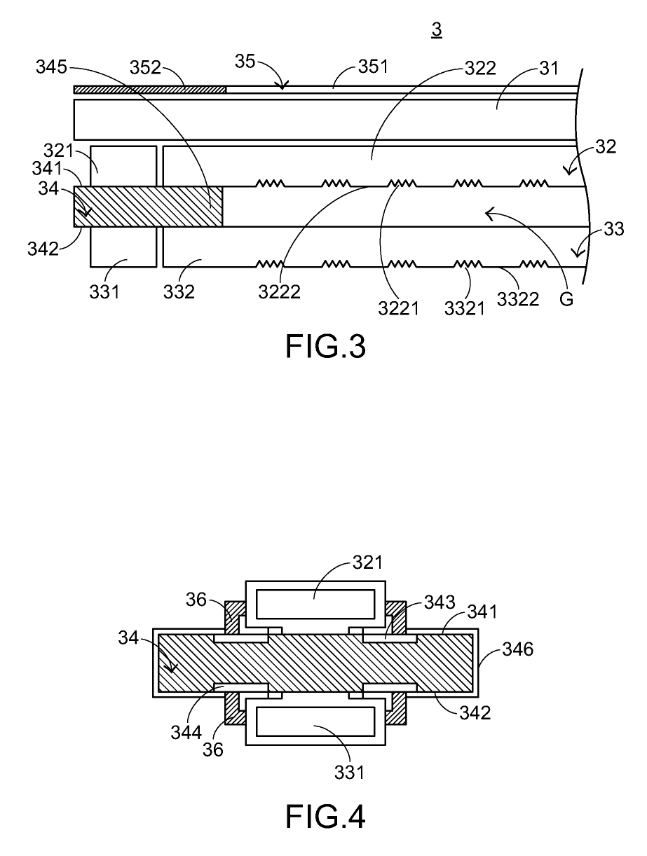

For obviating the drawbacks encountered from the prior art, the present invention provides an input device with multiple layers of luminous patterns. FIG. 3 is a schematic side view illustrating an input device with multiple layers of luminous patterns according to a first embodiment of the present invention. As shown in FIG. 3, the input device 3 comprises an input interface 31, a first illumination module 32, a second illumination module 33, a circuit board 34 and a protective layer 35. From bottom to top, the second illumination module 33, the circuit board 34, the first illumination module 32, the input interface 31 and the protective layer 35 are sequentially shown. In a case that the input interface 31 is triggered by a user's finger or a pen, a corresponding touching signal is generated. In this embodiment, the input interface 31 is light-transmissible resistive touch sensor.

The first illumination module 32 comprises a first light-emitting element 321 and a first light-guiding plate 322. The first light-emitting element 321 is used for emitting first light beams (not shown). The first light-guiding plate 322 is located beside the first light-emitting element 321 for guiding the first light beams to the input interface 31. In addition, the first light-guiding plate 322 has a plurality of first luminous patterns 3221. The first luminous patterns 3221 are disposed on a bottom surface 3222 of the first light-guiding plate 322. That is, when the first light beams are emitted by the first light-emitting element 321, the first luminous patterns 3221 of the first light-guiding plate 322 are visible.

The second illumination module 33 comprises a second light-emitting element 331 and a second light-guiding plate 332. The second light-emitting element 331 is used for emitting second light beams (not shown). The second light-guiding plate 332 is located beside the second light-emitting element 331 for guiding the second light beams to the input interface 31. In addition, the second light-guiding plate 332 has a plurality of second luminous patterns 3321. The second luminous patterns 3321 are disposed on a bottom surface 3322 of the second light-guiding plate 332. That is, when the second light beams are emitted by the second light-emitting element 331, the second luminous patterns 3321 of the second light-guiding plate 332 are visible.

In this embodiment, each of the first luminous patterns 3221 and the second luminous patterns 3321 includes a plurality of closely packed light-guiding microstructures. The light-guiding microstructures are for example closely packed microstructures (e.g. micro lenses or V-shaped notches) or closely packed dots. The light-guiding microstructures for constituting the luminous patterns may change the incidence angles of the light beams within the first light-guiding plate 322 or the second light-guiding plate 332. Since the uses of the light-guiding microstructures can destroy the total internal reflection path, the light beams are refracted and transmitted through the first light-guiding plate 322 or the second light-guiding plate 332. That is, the light beams are transmitted through the regions over the light-guiding microstructures, so that the first luminous patterns 3221 or the second luminous patterns 3321 are visible.

In this embodiment, these first luminous patterns 3221 are disposed on a bottom surface 3222 of the first light-guiding plate 322. The second luminous patterns 3321 are disposed on a bottom surface 3322 of the second light-guiding plate 332. Alternatively, in some other embodiments, the first luminous patterns are disposed on a top surface of the first light-guiding plate, and the second luminous patterns are disposed on a top surface of the second light-guiding plate.

Please refer to FIG. 3 again. The protective layer 35 is located over the input interface 31 for protecting the input interface 31. In addition, the protective layer 35 comprises a light-transmissible zone 351 and a light-shading zone 352. The light-shading zone 352 is located around the light-transmissible zone 351 (see also FIG. 5). The light-shading zone 352 is used for shading the first light beams, the second light beams or other external light beams. In response to the first light beams or the second light beams, the first luminous patterns 3221 or the second luminous patterns 3321 are visible through the light-transmissible zone 351. Moreover, the light-transmissible zone 351 has a preset light-shading percentage. For example, the preset light-shading percentage is in the range between 75% and 80%. The circuit board 34 is located beside the first illumination module 32 and the second illumination module 33. In addition, the circuit board 34 is parallel with the first light-guiding plate 322 and the second light-guiding plate 332.

FIG. 4 schematically illustrates the first light-emitting element and the second light-emitting element mounted on the circuit board of the input device with multiple layers of luminous patterns according to the first embodiment of the present invention and taken along another viewpoint. The circuit board 34 has a first metal contact 343 and a second metal contact 344. The first metal contact 343 is formed on a first surface 341 of the circuit board 34. The second metal contact 344 is formed on a second surface 342 of the circuit board 34. The first light-emitting element 321 is disposed on the first surface 341 of the circuit board 34. In addition, the first light-emitting element 321 is connected with the first metal contact 343 on the first surface 341 of the circuit board 34 through a soldering element 36. In this embodiment, the soldering element 36 is made of tin metal. The second light-emitting element 331 is disposed on the second surface 342 of the circuit board 34. The second light-emitting element 331 is also connected with the second metal contact 344 on the second surface 342 of the circuit board 34 through the soldering element 36. As shown in FIG. 4, the first light-emitting element 321 and the second light-emitting element 331 are side-view light emitting diodes. The circuit board 34 is further coated with a white glare solder-resistant ink layer 346. The first light beams and the second beams may be reflected by the white glare solder-resistant ink layer 346. In addition, the white glare solder-resistant ink layer 346 is formed on the first surface 341 and the second surface 342 of the circuit board 34 by printing.

Please refer to FIG. 3 again. The first illumination module 32 and the second illumination module 33 are separated from each other by a gap G. A first edge 345 of the circuit board 34 is inserted into the gap G. Consequently, the first light beams from the first light-emitting element 321 are blocked by the first edge 345 of the circuit board 34. Under this circumstance, the first light beams are not transmitted through the gap G to influence the second illumination module 33. Similarly, the second light beams from the second light-emitting element 331 are not transmitted through the gap G to influence the first illumination module 32.

In a case that the first illumination module 32 and the second illumination module 33 are disabled and the first light beams and the second light beams are not generated, the first luminous patterns 3221 of the first illumination module 32 and the second luminous patterns 3321 of the second illumination module 33 are invisible according to the preset light-shading percentage. The reason will be illustrated as follows. If no light beams are emitted by the first light-emitting element 321 and the second light-emitting element 331, only the external light beams from the surroundings are possibly incident into the light-transmissible zone 351 of the protective layer 35. Since the preset light-shading percentage of the light-transmissible zone 351 is in the range between 75% and 80%, about 75% and 80% of the light beams incident into the light-transmissible zone 351 are absorbed by the light-transmissible zone 351. That is, the rest (i.e. 20˜25%) of the light beams are transmitted through the input interface 31 and directed to the first light-guiding plate 322. After the light-guiding microstructures on the bottom surface 3222 of the first light-guiding plate 322 are hit by the rest (i.e. 20-25%) of the light beams, about a half of these light beams are refracted and continuously directed toward the region under the first light-guiding plate 322 because the incidence angles of the light beams projected on the light-guiding microstructures are different. That is, only about 10% of the light beams are reflected by the light-guiding microstructures and directed toward the input interface 31. After the light beams are reflected to the input interface 31, portions of the light beams are absorbed by the light-transmissible zone 351 again. Meanwhile, only about 2% of the light beams are transmitted through the light-transmissible zone 351. Since the light beam intensity is too weak, the first luminous patterns 3221 and the second luminous patterns 3321 are invisible through the input interface 31. Under this circumstance, the first luminous patterns 3221 and the second luminous patterns 3321 fail to be viewed by the user.

FIG. 5 is a schematic top view illustrating the input device with multiple layers of luminous patterns according to the first embodiment of the present invention, in which the first light-emitting element of the first illumination module is turned on. After the first illumination module is enabled and the first light-emitting element 321, a great number of first light beams are laterally incident into the first light-guiding plate 322. Moreover, portions of the first light beams are blocked by the first edge 345 of the circuit board 34 and reflected by the white glare solder-resistant ink layer 346 on the surface of the circuit board 34. Consequently, the portions of the first light beams are directed into the first light-guiding plate 322 again. When the first light beams within the first light-guiding plate 322 are directed to the first luminous patterns 3221 that is constructed by the light-guiding microstructures, the first light beams are directed toward the region over the first light-guiding plate 322 because the total internal reflection path is destroyed by the light-guiding microstructures. When the first light beams are transmitted through the input interface 31 and directed to the light-transmissible zone 351 of the protective layer 35, about 75% and 80% of the light beams are absorbed by the light-transmissible zone 351. That is, about 20˜25% of the first light beams are allowed to be transmitted through the light-transmissible zone 351, and the first luminous patterns 3221 are visible through the input interface 31 and viewed by the user (see FIG. 5).

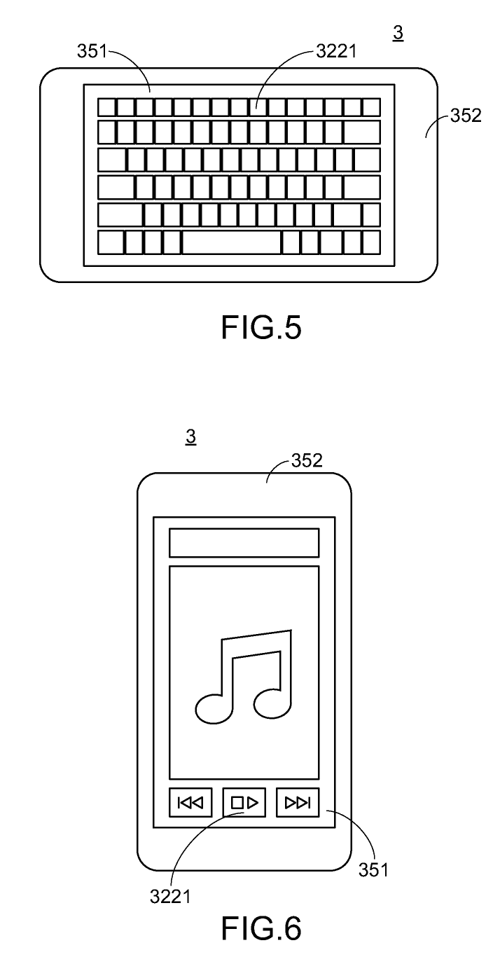

The operations of enabling the second illumination module 33 of the input device 3 are similar to those of the first illumination module 32, and are not redundantly described herein. That is, after the second illumination module 33 is enabled, the second luminous patterns 3321 are visible (see FIG. 6). As shown in FIGS. 5 and 6, the first luminous patterns 3221 are collectively defined as an alphanumeric keyboard interface for inputting letters and numbers, and the second luminous patterns 3321 are collectively defined as a music playback interface for controlling the playback of the music.

In the input device 3 according to the first embodiment of the present invention, the circuit board 34 is parallel with the first light-guiding plate 322 and the second light-guiding plate 332. Consequently, the thickness of the input device 3 can be reduced, and the purpose of providing the slim input device can be achieved. Moreover, since the first light beams and the second light beams can be shaded by the circuit board 34, it is not necessary to install any additional light-shading element in the input device 3. Under this circumstance, the input device is cost-effective.

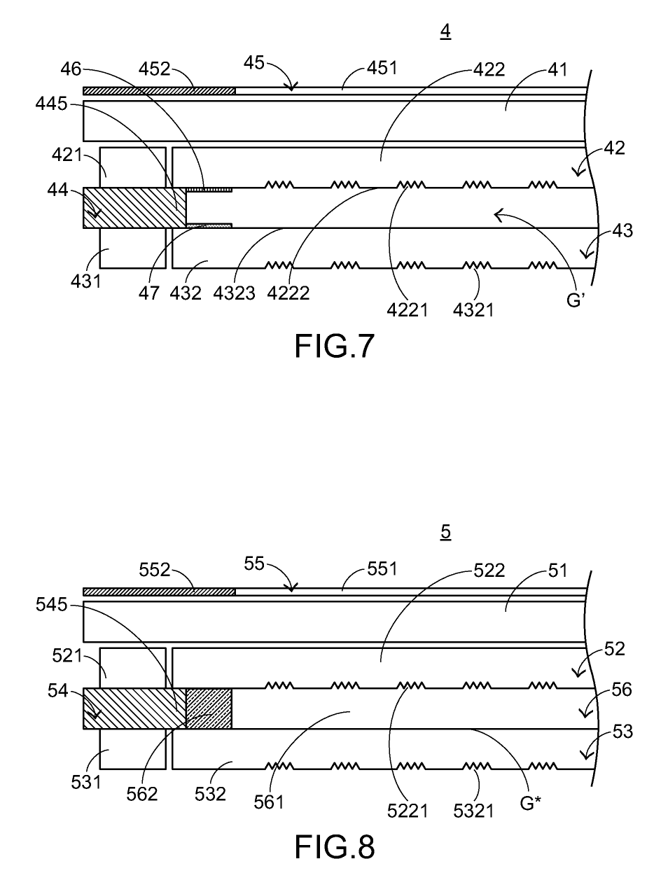

The present invention further provides a second embodiment. FIG. 7 is a schematic side view illustrating an input device with multiple layers of luminous patterns according to a second embodiment of the present invention. As shown in FIG. 7, the input device 4 comprises an input interface 41, a first illumination module 42, a second illumination module 43, a circuit board 44, a protective layer 45, a first light-shading structure 46 and a second light-shading structure 47. From bottom to top, the second illumination module 43, the second light-shading structure 47, the circuit board 44, the first light-shading structure 46, the first illumination module 42, the input interface 41 and the protective layer 45 are sequentially shown. In a case that the input interface 41 is triggered by a user's finger, a corresponding touching signal is generated. In this embodiment, the input interface 41 is light-transmissible capacitive touch sensor. The first illumination module 42 comprises a first light-emitting element 421 and a first light-guiding plate 422. In addition, the first light-guiding plate 422 has a plurality of first luminous patterns 4221. The second illumination module 43 comprises a second light-emitting element 431 and a second light-guiding plate 432. In addition, the second light-guiding plate 432 has a plurality of second luminous patterns 4321. The protective layer 45 is located over the input interface 41 for protecting the input interface 41. In addition, the protective layer 45 comprises a light-transmissible zone 451 and a light-shading zone 452.

Except for the following two items, the configurations and functions of the input device of the second embodiment are similar to those of the first embodiment, and are not redundantly described herein. Firstly, the first edge 445 of the circuit board 44 is not inserted into the gap G′ between the first illumination module 42 and the second illumination module 43. Secondly, the input device 4 of this embodiment is additionally equipped with the first light-shading structure 46 and the second light-shading structure 47. The first light beams from the first light-emitting element 46 are blocked by the first light-shading structure 46. Consequently, the first light beams are not transmitted through the gap G′ to influence the second illumination module 43. Moreover, the second light beams from the second light-emitting element 431 are blocked by the second light-shading structure 47. Consequently, the second light beams are not transmitted through the gap G′ to influence the first illumination module 42.

Please refer to FIG. 7 again. The first light-shading structure 46 is disposed on a bottom surface 4222 of the first light-guiding plate 422. Moreover, the first light-shading structure 46 is formed by painting, spraying, printing or bonding a light-shading material on the bottom surface 4222 of the first light-guiding plate 422. The second light-shading structure 47 is disposed on a top surface 4323 of the second light-guiding plate 432. Moreover, the second light-shading structure 47 is formed by painting, spraying, printing or bonding a light-shading material on the top surface 4323 of the second light-guiding plate 432. In this embodiment, the first light-shading structure 46 is a light-shading layer, which is formed by coating the bottom surface 4222 of the first light-guiding plate 422 with light-shading ink. In addition, the second light-shading structure 47 is a light-shading tape, which is boned on the top surface 4323 of the second light-guiding plate 432.

In the input device 4 according to the second embodiment of the present invention, the circuit board 44 is also parallel with the first light-guiding plate 422 and the second light-guiding plate 432. Consequently, the thickness of the input device 4 can be reduced, and the purpose of providing the slim input device can be achieved.

The present invention further provides a third embodiment. FIG. 8 is a schematic side view illustrating an input device with multiple layers of luminous patterns according to a third embodiment of the present invention. As shown in FIG. 8, the input device 5 comprises an input interface 51, a first illumination module 52, a second illumination module 53, a circuit board 54, a protective layer 55 and a light-shading structure 56. From bottom to top, the second illumination module 53, the circuit board 54 (or the light-shading structure 56), the first illumination module 52, the input interface 51 and the protective layer 55 are sequentially shown. In a case that the input interface 51 is triggered by a user's finger, a corresponding touching signal is generated. In this embodiment, the input interface 51 is light-transmissible capacitive touch sensor. The first illumination module 52 comprises a first light-emitting element 521 and a first light-guiding plate 522. In addition, the first light-guiding plate 522 has a plurality of first luminous patterns 5221. The second illumination module 53 comprises a second light-emitting element 531 and a second light-guiding plate 532. In addition, the second light-guiding plate 532 has a plurality of second luminous patterns 5321. The protective layer 55 is located over the input interface 51 for protecting the input interface 51. In addition, the protective layer 55 comprises a light-transmissible zone 551 and a light-shading zone 552.

In this embodiment, the light-shading structure 56 is disposed within the gap G* between the first light-guiding plate 522 and the second light-guiding plate 532. In addition, the light-shading structure 56 is located at a first side 545 of the circuit board 54. The configurations and functions of the other components of input device of the third embodiment are similar to those of the second embodiment, and are not redundantly described herein. An example of the light-shading structure 56 includes but is not limited to a plastic sheet, a sponge structure or a light-shading plate.

In this embodiment, the light-shading structure 56 is a plastic sheet. In addition, the light-shading structure 56 comprises another light-transmissible zone 561 and another light-shading zone 562. The light-transmissible zone 561 is aligned with the first luminous patterns 5221 and the second luminous patterns 5321. Consequently, the first luminous patterns 5221 and the second luminous patterns 5321 are visible. The light-shading zone 562 is located at the first side 545 of the circuit board 54 for blocking the first light beams and the second light beams that are emitted by the first light-emitting element 521 and the second light-emitting element 531. Consequently, the first light beams and the second light beams are not transmitted through the gap G* to influence the second illumination module 53 and the first illumination module 52.

From the above description, the input device of the present invention has multiple layers of luminous patterns. In the input device, the circuit board is parallel with the first light-guiding plate and the second light-guiding plate. Moreover, the side-view light emitting diodes are employed in the input device. As previously described in the conventional input device 2, the circuit board is perpendicular to the light-guiding plate. In comparison with the conventional input device, the input device of the present invention is slimmer. That is, the thickness of the input device of the present invention is reduced. Moreover, in a case that the first edge of the circuit board is inserted into the gap between the first light-guiding plate and the second light-guiding plate, the first light beams and the second light beams can be blocked by the first edge of the circuit board. Since the input device has no additional light-shading element, the fabricating cost is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An input device with multiple layers of luminous patterns, said input device comprising:
an input interface, wherein a touching signal is generated when said input interface is triggered;
a circuit board disposed under said input interface;
a first illumination module disposed on a first surface of said circuit board for emitting first light beams, wherein said first illumination module has a first luminous pattern, wherein when said first light beams are transmitted through said input interface, said first luminous pattern is visible through said input interface; and
a second illumination module disposed on a second surface of said circuit board for emitting second light beams, wherein said second illumination module has a second luminous pattern, wherein when said second light beams are transmitted through said input interface, said second luminous pattern is visible through said input interface,
wherein a first edge of said circuit board is inserted into a gap between said first illumination module and said second illumination module for blocking said first light beams or said second light beams.

2. The input device according to claim 1 further comprising a protective layer, which is disposed over said input interface for protecting said input interface, wherein said protective layer comprises a light-transmissible zone and a light-shading zone, and said light-shading zone is located around said light-transmissible zone for shading said first light beams or said second light beams, wherein in response to said first light beams or said second light beams, said first luminous pattern or said second luminous pattern are visible through said light-transmissible zone, and said light-transmissible zone has a preset light-shading percentage, wherein if said first illumination module or said second illumination module is disabled and said first light beams or said second light beams are not generated, said first luminous pattern of said first illumination module or said second illumination module of said second luminous pattern is invisible according to said preset light-shading percentage.

3. The input device according to claim 2 wherein if said first light beams or said second light beams are not generated, an external light beam from surroundings of said input device is blocked by said light-shading zone having said preset light-shading percentage, so that said first luminous pattern or said second luminous pattern is invisible, wherein said preset light-shading percentage is in a range between 75% and 80%.

4. The input device according to claim 1 wherein said first illumination module comprises a first light-emitting element and a first light-guiding plate, wherein said first light-emitting element is disposed on said first surface of said circuit board for emitting said first light beams, and said first light-guiding plate is stacked on said first surface of said circuit board and located at a first side of said first light-emitting element for guiding said first light beams to said input interface, wherein said second illumination module comprises a second light-emitting element and a second light-guiding plate, said second light-emitting element is disposed on said second surface of said circuit board for emitting said second light beams, and said second light-guiding plate is stacked on said second surface of said circuit board and located at a first side of said second light-emitting element for guiding said second light beams to said input interface.

5. The input device according to claim 4 wherein said first light-emitting element and said second light-emitting element are both side-view light emitting diodes, and said circuit board is parallel with said first light-guiding plate and said second light-guiding plate.

6. The input device according to claim 4 wherein said first luminous pattern is disposed on a top surface or a bottom surface of said first light-guiding plate, and said second luminous pattern is disposed on a top surface or a bottom surface of said second light-guiding plate, wherein each of said first luminous pattern and said second luminous pattern includes a plurality of closely packed light-guiding microstructures.

7. The input device according to claim 1 wherein a white glare solder-resistant ink layer is further formed on said circuit board for reflecting said first light beams or said second light beams, wherein said white glare solder-resistant ink layer is printed on said first surface and said second surface of said circuit board.

8. An input device with multiple layers of luminous patterns, said input device comprising:
an input interface, wherein a touching signal is generated when said input interface is triggered;
a circuit board disposed under said input interface;
a first illumination module disposed on a first surface of said circuit board for emitting first light beams, wherein said first illumination module has a first luminous pattern, wherein when said first light beams are transmitted through said input interface, said first luminous pattern is visible through said input interface;
a second illumination module disposed on a second surface of said circuit board for emitting second light beams, wherein said second illumination module has a second luminous pattern, wherein when said second light beams are transmitted through said input interface, said second luminous pattern is visible through said input interface; and
a light-shading structure located at a first side of said circuit board and arranged between said first illumination module and said second illumination module for blocking said first light beams or said second light beams.

9. The input device according to claim 8 further comprising a protective layer, which is disposed over said input interface for protecting said input interface, wherein said protective layer comprises a light-transmissible zone and a light-shading zone, and said light-shading zone is located around said light-transmissible zone for shading said first light beams or said second light beams, wherein in response to said first light beams or said second light beams, said first luminous pattern or said second luminous pattern are visible through said light-transmissible zone, and said light-transmissible zone has a preset light-shading percentage, wherein if said first illumination module or said second illumination module is disabled and said first light beams or said second light beams are not generated, said first luminous pattern or said second luminous pattern is invisible by said first illumination module or said second illumination module according to said preset light-shading percentage.

10. The input device according to claim 9 wherein if said first light beams or said second light beams are not generated, an external light beam from surroundings of said input device is blocked by said light-shading zone having said preset light-shading percentage, so that said first luminous pattern or said second luminous pattern is invisible, wherein said preset light-shading percentage is in a range between 75% and 80%.

11. The input device according to claim 8 wherein said first illumination module comprises a first light-emitting element and a first light-guiding plate, wherein said first light-emitting element is disposed on said first surface of said circuit board for emitting said first light beams, and said first light-guiding plate is stacked on said first surface of said circuit board and located at a first side of said first light-emitting element for guiding said first light beams to said input interface, wherein said second illumination module comprises a second light-emitting element and a second light-guiding plate, said second light-emitting element is disposed on said second surface of said circuit board for emitting said second light beams, and said second light-guiding plate is stacked on said second surface of said circuit board and located at a first side of said second light-emitting element for guiding said second light beams to said input interface.

12. The input device according to claim 11 wherein said first light-emitting element and said second light-emitting element are both side-view light emitting diodes, and said circuit board is parallel with said first light-guiding plate and said second light-guiding plate.

13. The input device according to claim 12 wherein said first luminous pattern is disposed on a top surface or a bottom surface of said first light-guiding plate, and said second luminous pattern is disposed on a top surface or a bottom surface of said second light-guiding plate, wherein each of said first luminous pattern and said second luminous pattern includes a plurality of closely packed light-guiding microstructures.

14. The input device according to claim 11 wherein said light-shading structure is disposed on a bottom surface of said first light-guiding plate or a top surface of said second light-guiding plate, wherein said light-shading structure is formed by painting, spraying, printing or bonding a light-shading material on said bottom surface of said first light-guiding plate or said top surface of said second light-guiding plate.

15. The input device according to claim 11 wherein said light-shading structure is a plastic sheet, a sponge structure or a light-shading plate, wherein said light-guiding structure is disposed within a gap between said first light-guiding plate and said second light-guiding plate and located at a first side of said circuit board.

16. The input device according to claim 8 wherein a white glare solder-resistant ink layer is further formed on said circuit board for reflecting said first light beams or said second light beams, wherein said white glare solder-resistant ink layer is printed on said first surface and said second surface of said circuit board.
